(19) United States
(12) Patent Application Publication
(10) Pub. No.: US 2024/0388246 A1
(43) Pub. Date: Nov. 21, 2024

(54) ADJUSTABLE SOLAR TRACKER BRIDGES

(71) Applicant: Nextracker LLC, Fremont, CA (US)

(72) Inventors: Abhimanyu Anil Sable, Hyderabad (IN); Ashwajit Wahane, Kalyan (IN); Jitendra Morankar, Hyderabad (IN); Phani Kumar, Hyderabad (IN)

(21) Appl. No.: 18/664,637

(22) Filed: May 15, 2024

Related U.S. Application Data
(60) Provisional application No. 63/466,981, filed on May 16, 2023.

(51) Int. Cl. H02S 40/10; H02S 20/32

(52) U.S. Cl. CPC H02S 40/10; H02S 20/32

(57) ABSTRACT

An autonomous cleaning system bridge includes a pair of parallel beams and a pair of transverse beam assemblies interposed between the pair of parallel beams and disposed in spaced relation to one another. Each transverse beam assembly includes an outer tube extending between a first end portion coupled to a first parallel beam and an opposite, second end portion, an insert coupled to the second end portion and defining a through-bore, and an inner tube extending between a first end portion and an opposite, second end portion, the second end portion of the inner tube coupled to a second parallel beam, wherein the inner tube is slidably supported within the through-bore to enable to autonomous cleaning system bridge to transition from a first, expanded configuration to a second, collapsed configuration due to contact between the second parallel beam and a portion of a solar tracker system.

### PRIORITY APPLICATION

This application claims the benefit of U.S. Provisional Patent Application No. 63/466,981, filed May 16, 2023, the entire contents of which are incorporated herein by reference.

### FIELD

The present disclosure relates to solar power generation systems, and more particularly, to autonomous cleaning system bridges for photovoltaic modules.

### BACKGROUND

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length.

As can be appreciated, the ability of the solar cells to generate electrical energy is diminished as the surface of the solar cells becomes dirty, through dust, soil, pollen, etc. As the layer of dust becomes thicker, or the layer covers more surface area of the solar cells, the amount of energy generated is diminished and the solar panel system will not perform at peak efficiency. Further, dust partially or fully covering the surface of the solar cells can cause hot spots to form on the uncovered portions of the solar cell, causing accelerated degradation of the solar cell.

In view of the numerous issues caused by dirty solar cells, it is important to regularly clean the surface of the cells to ensure the solar panel system operates as close to peak efficiency as possible. Typically, the numerous solar panels are cleaned using a specialized vehicle or manually using water. As can be appreciated, such cleaning requires enormous manpower, as the size of the solar system may cover several acres. The present disclosure seeks to address the shortcomings of prior solar tracker cleaning systems.

### SUMMARY

In accordance with an aspect of the present disclosure, an autonomous cleaning system bridge includes a pair of parallel beams and a pair of transverse beam assemblies interposed between the pair of parallel beams and disposed in spaced relation to one another, each transverse beam assembly of the pair of transverse beam assemblies including an outer tube extending between a first end portion and an opposite, second end portion, the first end portion of the outer tube couple to a first parallel beam of the pair of parallel beams, an insert coupled to the second end portion of the outer tube, the insert defining a through bore, and an inner tube extending between a first end portion and an opposite, second end portion, the second end portion of the inner tube coupled to a second parallel beam of the pair of parallel beams, wherein the inner tube is slidably supported within the through-bore of the insert to enable the autonomous cleaning system bridge to transition from a first, expanded configuration to a second, collapsed configuration due to contact between the second parallel beam of the pair of parallel beams and a portion of a solar tracker system.

In aspects, the portion of the solar tracker system may be a mechanical linkage coupling a first row of solar modules to a second row of solar modules.

In certain aspects, the insert may be formed from a polymer.

In other aspects, a flange may be defined on the first end portion of the inner tube to limit translation of the inner tube relative to the outer tube.

In certain aspects, the insert may be coupled to the outer tube by a snap fit.

In aspects, the insert may be coupled to the outer tube by a friction fit.

In other aspects, the insert may be coupled to the outer tube using fasteners.

In aspects, the pair of parallel beams may define an arcuate center portion to provide clearance between the pair of parallel beams and a component of a solar tracking system.

In accordance with another aspect of the present disclosure, an autonomous cleaning system bridge includes a pair of parallel beams and a pair of transverse beam assemblies interposed between the pair of parallel beams and disposed in spaced relation to one another, wherein each transverse beam assembly of the pair of transverse beam assemblies is transitionable from a first position, permitting an autonomous cleaning system to traverse the autonomous cleaning system bridge, to a second position in response to contact between a parallel beam of the pair of parallel beams with a portion of a solar tracking system.

In certain aspects, the portion of the solar tracking system may be a mechanical linkage coupling a first row of solar modules to a second row of solar modules.

In aspects, the first position of the pair of transverse beam assemblies may define a linear configuration.

In other aspects, the second position of the pair of transverse beam assemblies may define a folded configuration.

In aspects, each transverse beam assembly of the pair of transverse beam assemblies may include a first tube and a second tube hingedly coupled to the first tube.

In certain aspects, the first position of the pair of transverse beam assemblies may define an expanded configuration and the second position may define a collapsed configuration.

In other aspects, each transverse beam assembly of the pair of transverse beam assemblies may include a first tube and a second tube slidably supported within the first tube.

In accordance with yet another embodiment of the present disclosure, an autonomous cleaning system bridge includes a pair of parallel beams and a pair of transverse beam assemblies interposed between the pair of parallel beams and disposed in spaced relation to one another, each transverse beam assembly of the pair of transverse beam assemblies including a first tube extending between a first end portion and an opposite, second end portion, the first end portion of the first tube coupled to a first parallel beam of the pair of parallel beams, a second tube extending between a first end portion and an opposite, second end portion, the second end portion of the second tube coupled to a second parallel beam of the pair of parallel beams, and a hinge coupled to the second end portion of the first tube and the first end portion of the second tube, the hinge permitting rotation of the first tube and the second tube relative to one another from a first position to a second position due to contact between second parallel beam of the pair of parallel beams and a portion of a solar tracker system.

In aspects, the portion of the solar tracking system may be a mechanical linkage coupling a first row of solar modules to a second row of solar modules.

In certain aspects, the first position of the pair of transverse beam assemblies may define a linear configuration.

In other aspects, the second position of the pair of transverse beam assemblies may define a folded configuration.

In aspects, the hinge may be coupled to an outer surface of the first tube and an outer surface of the second tube.

### BRIEF DESCRIPTION OF THE DRAWINGS

Various aspects and features of the present disclosure are described hereinbelow with reference to the drawings, wherein:

FIG. 1 a plan view of a solar tracking system in accordance with the present disclosure;

FIG. 1A is an enlarged view of the area of detail indicated in FIG. 1;

FIG. 2 is a perspective view of an autonomous cleaning system bridge of the solar tracking system of FIG. 1, shown in an expanded configuration;

FIG. 3 is a perspective view of the autonomous cleaning system bridge of FIG. 2 shown in a collapsed configuration;

FIG. 4 is a detailed view of an interface between an outer tube and an inner tube of the autonomous cleaning system bridge of FIG. 2;

FIG. 5 is an exploded, perspective view of an outer tube and an insert of the autonomous cleaning system bridge of FIG. 2;

FIG. 6 is a perspective view of another embodiment of the insert of FIG. 5;

FIG. 7 is a side view of the insert of FIG. 6;

FIG. 8 is a side view of yet another embodiment of the insert of FIG. 5;

FIG. 9 is a side view of still another embodiment of the insert of FIG. 5;

FIG. 10 is a side view of another embodiment of the insert of FIG. 5;

FIG. 11 is a side view of yet another embodiment of the insert of FIG. 5;

FIG. 12 is a side, elevation view of the autonomous cleaning system bridge of FIG. 2 shown in an expanded configuration; and

FIG. 13 is a side, elevation view of the autonomous cleaning system bridge of FIG. 2 shown in a collapsed configuration;

FIG. 14 is a perspective view of another embodiment of an autonomous cleaning system bridge provided in accordance with the present disclosure;

FIG. 15 is a side, elevation view of the autonomous cleaning system bridge of FIG. 14;

FIG. 16 is a side, elevation view of the autonomous cleaning system bridge of FIG. 14 shown in an unfolded configuration; and

FIG. 17 is a side, elevation view of the autonomous cleaning system bridge of FIG. 14 shown in a folded configuration.

### DETAILED DESCRIPTION

The present disclosure is directed to mechanisms for storage and transport of cleaning equipment over a length of solar panels. As can be appreciated, in an effort to extract as much solar energy as possible, solar trackers have been developed that are quite large, spanning hundreds of feet in length. Further, to extract energy more efficiently, solar tracking systems rotate solar modules to maintain a desired orientation towards the sun as the sun traverses the sky from east to west. To accommodate this movement, the solar tracking systems are broken up into numerous sections along their length to minimize tortional loads and deflection, and to accommodate various mechanical systems, such as gear drives, communication antennae, amongst others. As such, gaps are formed between adjacent solar modules that inhibit the free movement of the cleaning equipment across an entire length of a tracking system.

The present disclosure includes bridges configured to permit the free movement of the solar modules while permitting movement of cleaning equipment across and the entire row of solar modules. The autonomous cleaning system bridges are provided in accordance with the present disclosure to bridge a gap formed between adjacent solar modules where slew drives or other electromechanical systems are located. In this manner, the autonomous cleaning system bridges enable the cleaning equipment to traverse an entire length of a solar tracker to reduce the amount of cleaning equipment required to clean the solar modules of a solar tracker farm.

Further, to reduce the wind loading exerted on the torque tubes of each row of solar trackers, the torque tubes of adjacent solar trackers may be linked or coupled to a mechanical linkage. The mechanical linkage transfers force exerted on one torque tube due to wind loading to the adjacent torque tube. As can be appreciated, as the solar trackers rotate to follow the orientation of the sun, the autonomous cleaning system bridges may contact the mechanical linkage and inhibit further rotation of the solar trackers or damage the autonomous cleaning system bridges, the mechanical linkages, the solar modules, etc.

To alleviate this issue, the autonomous cleaning system bridges described herein include telescoping portions or hingedly connected portions that permit the autonomous cleaning system bridges to deflect or otherwise change shape when contacting a mechanical linkage, thereby allowing the solar tracker to freely rotate throughout its entire range without damage to either the solar tracker or the autonomous cleaning system bridges. These and other aspects of the present disclosure will be described in further detail herein.

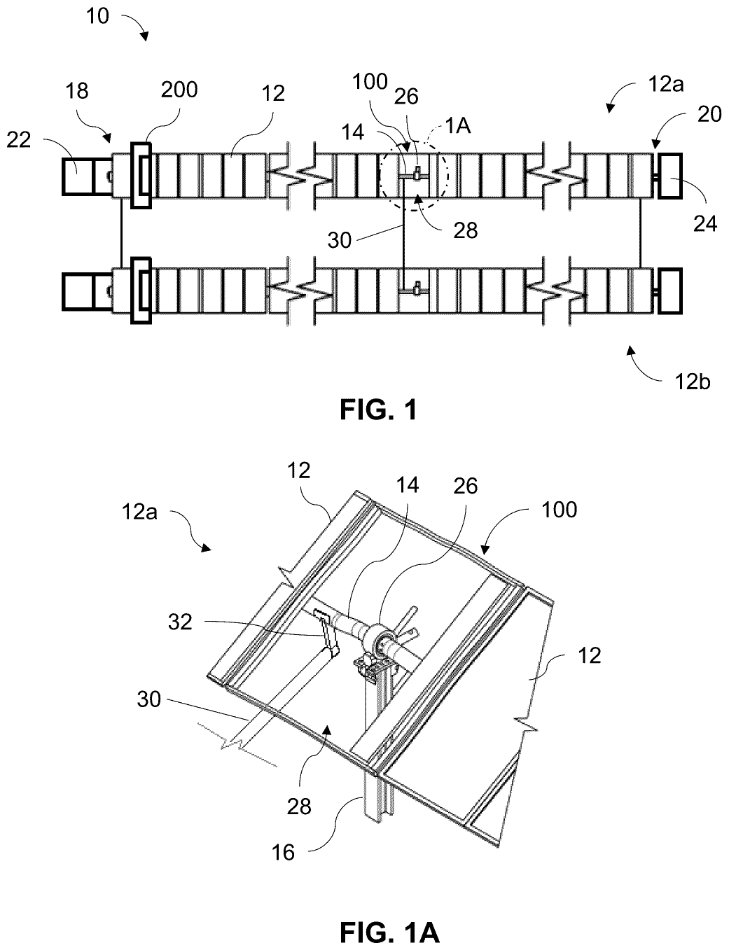

Referring now to the drawings, a solar tracking system is illustrated in FIG. 1 and generally identified by reference numeral 10. The solar tracking system 10 includes one or more solar modules 12 disposed adjacent to one another to form a continuous row. The continuous row of solar modules 12 is coupled to a torque tube 14, which is rotatably supported on one or more piers 16 (FIG. 1A). As can be appreciated, the solar tracking system 10 may include multiple rows of solar modules depending upon the design needs of the solar tracking system 10. In this manner, any number of rows of solar modules 12 may be utilized, including a single row of solar modules 12, without departing from the scope of the present disclosure. For purposes of brevity, only two rows of solar modules 12 will be described herein, identified by reference numerals 12a and 12b, respectively. Each row 12a, 12b of solar modules 12 is substantially similar to one another, and therefore, only one row of solar modules 12a will be described herein in the interest of brevity.

The row of solar modules 12a includes a first end portion 18 and an opposite, second end portion 20. In embodiments, the first end portion 18 includes a docking station 22 disposed adjacent thereto to provide a space for cleaning equipment 300 to dock or otherwise be retained when the cleaning equipment 300 is not in use. The second end portion 20 of the solar tracking system 10 includes a return station 24 disposed adjacent thereto to provide a location at which the cleaning equipment 300 may traverse to enable the cleaning equipment 300 to fully clean the last solar module 12 of the row of solar modules 12a and to provide a means to alert the cleaning equipment 300 that it has reached the end of the row of solar modules 12a and to inhibit the cleaning equipment 300 from falling off or otherwise becoming disengaged from the solar tracking system 10. Although generally described as having one of each of the docking station 22 and the return station 24, it is envisioned that the row of solar modules 12a may include two docking stations 22, two return stations 24, only one of the docking station or return station 24, and the location of the docking station 22 and 24 may be altered depending upon the design needs of the solar tracking system 10.

The solar tracking system 10 includes numerous slew drives 26 disposed on a respective pier 16 (FIG. 1A) for effectuating rotation of the torque tube 14, and therefore, rotation of the row of solar modules 12a during tracking of the sun. As can be appreciated, a gap 28 or other interruption is formed between adjacent solar modules 12 of the row of solar modules 12a which may interfere with and inhibit movement of the cleaning equipment 300 thereacross. An autonomous cleaning system bridge 100 is provided at these locations to enable the cleaning equipment 300 to traverse the gap 28 formed between adjacent solar modules 12 of the row of solar modules 12a adjacent the slew drive 26. Although generally described as bridging a gap over the slew drive 26, it is envisioned that the autonomous cleaning system bridge 100 may be utilized at any suitable location along the length of row of solar modules 12a. As can be appreciated, due to the large size of the row of solar modules 12a, 12b, it is necessary to limit the overall length of each row of solar modules 12a. Accordingly, a gap (not shown) is formed between adjacent sections a row of solar modules 12a. 12b which may interfere with and inhibit movement of the cleaning equipment 300 thereacross. To enable the transition of the cleaning equipment 300 from one section of a row of solar modules 12a, 12b to the next, it is envisioned that the autonomous cleaning system bridge 100 may be utilized to bridge the gap formed between adjacent sections of the row of solar modules 12a.

The solar tracking system 10 includes one or more mechanical linkages 30 (e.g., mechanical links) operably coupled to a torque tube 14 of each respective row of solar modules 12a, 12b adjacent to a slew drive 26 or pier 16, although it is contemplated that the mechanical link 30 may be disposed at any suitable location along the length of each row of solar modules 12a, 12b without departing from the scope of the present disclosure. It is contemplated that the mechanical linkage 30 may be formed from any suitable material, such as steel, aluminum, composites, polymers, amongst others, and may include any suitable profile, such as circular, oval, elliptical, square hexagonal, amongst others, and may be formed from more than one material or include more than one profile along its length.

The mechanical linkage 30 is coupled to the torque tube 14 using a bracket or flange 32 having a first end portion coupled to the torque tube 14 and a second end portion coupled to the mechanical linkage 30. It is envisioned that the bracket 32 may be formed from any suitable material, such as steel, aluminum, polymers, composites, amongst others and may be formed using any suitable process, such as stamping, molding, machining, hydroforming, welding, almost others. The bracket 32 is selectively or fixedly coupled to the torque tube 14 using any suitable means, such as fasteners, welding, adhesives, etc. and is selectively or fixedly coupled to the mechanical linkage 30 using any suitable means such as fasteners, welding, adhesives, amongst others. The mechanical linkage 30 may be rotatably coupled to the bracket 32 to permit rotation of the mechanical linkage 30 relative to the bracket 32. It is envisioned that the mechanical linkage 30 may be rotatably coupled to the bracket 32 using any suitable means, such as bearings, bushings, amongst others. As can be appreciated, the mechanical linkage 30 transmits force or loads applied to the torque tube 14 of one row of solar modules 12a to the torque tube 14 of the other row of solar modules 12b, and vice versa. In this manner, external forces, such as wind loading, the weight of debris, snow, foreign objects, etc. exerted on the rows of solar modules 12a, 12b may be shared or otherwise transferred between each torque tube 14 of the rows of solar modules 12a, 12b and reduce the load applied to each torque tube 14.

With additional reference to FIGS. 1A, as the rows of solar modules 12a, 12b rotate to follow the orientation of the sun, the autonomous cleaning system bridge 100 may contact the mechanical linkage 30 and inhibit further rotation of the row of solar modules 12a, 12b. As can be appreciated, contact between the mechanical linkage 30 and the autonomous system bridge 100 may also damage the autonomous cleaning system bridge 100, the mechanical linkage 30, the solar modules 12, the slew drive 26, in addition to other components of the rows of solar modules 12a, 12b.

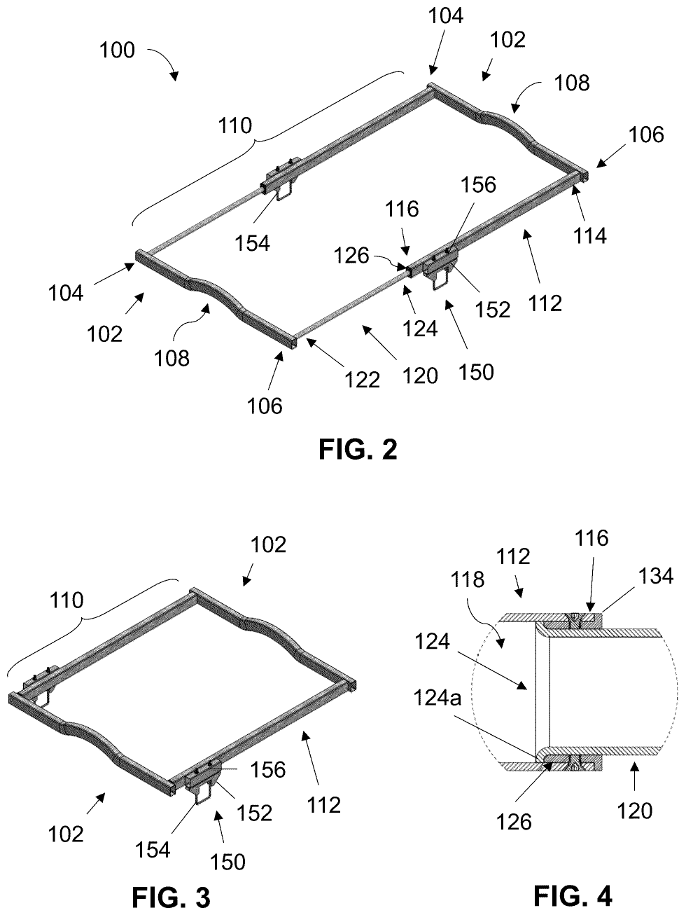

Turning to FIGS. 2-6, an embodiment of the autonomous cleaning system bridge 100 includes a pair of parallel beams 102, a pair of transverse beam assemblies 110, and a pair of torque tube clamps 150. Each parallel beam of the pair of parallel beams 102 is substantially similar and therefore only one parallel beam 102 will be described in detail herein in the interest of brevity. The parallel beam 102 extends between a first end portion 104 and an opposite, second end portion 106. The parallel beam 102 defines an arcuate center portion 108 to provide clearance for the slew drive (FIG. 1A), antenna (not shown), or other device disposed on the solar tracker system 10. Although generally described as having an arcuate center portion 108, it is envisioned that the parallel beam 102 may include any suitable profile along its length, such as a top hat configuration, an oval configuration, a triangular configuration, a trapezoidal profile, etc. without departing from the scope of the present disclosure. Although generally illustrated as having a rectangular profile, it is contemplated that the parallel beam 102 may include any suitable profile, such as square, circular, oval, amongst others. In one non-limiting embodiment, the parallel beam 102 is formed from a rectangular tube (e.g., box tubing, etc.) having a hollow interior portion.

Each of the transverse beam assemblies 110 is substantially similar and therefore only one transverse beam assembly 110 will be described in detail herein in the interest of brevity. The transverse beam assembly 110 includes an outer tube 112, an inner tube 120, and an insert 126. The outer tube 112 defines a generally rectangular profile extending between a first end portion 114 and an opposite, second end portion 116. Although generally described as having a rectangular profile, it is envisioned that the outer tube 112 may include any suitable profile, such as circular, square, oval, hexagonal, amongst others and may define one or more profiles over its length. An interior channel 118 (FIG. 4) is defined within the outer tube 112 and extends longitudinally through at least the second end portion 116 of the outer tube 112, although it is contemplated that the interior channel 118 may extend through both the first and second end portions 114, 116. In one non-limiting embodiment, the outer tube 112 is formed from a rectangular tube (e.g., box tubing, etc.) having a hollow interior portion. The first end portion 114 of the outer tube 112 is coupled to a first parallel beam of the pair of parallel beams 102 adjacent the first end portion 104 of the first parallel beam 102. It is envisioned that the outer tube 112 may be coupled to the parallel beam 102 using any suitable means, such as fasteners, welding, adhesives, amongst others.

The inner tube 120 defines a generally circular profile extending between a first end portion 122 and a second, opposite end portion 124. Although generally described as having a circular profile, it is envisioned that the inner tube 120 may include any suitable profile, such as rectangular, square, oval, hexagonal, amongst others. In embodiments, the inner tube 120 may be a hollow tube (e.g., circular tube stock, etc.) or may a solid tubular bar. The inner tube 120 includes an outer dimension that is less than an inner dimension of the interior channel 118 of the outer tube 112 to enable the inner tube 120 to be slidably received within the interior channel 118 of the outer tube 112 and selectively alter a length of the transverse beam assembly 110 from a first, expanded configuration (FIG. 2) to a second, collapsed configuration (FIG. 3), as will be described in further detail hereinbelow. The first end portion 122 of the inner tube is coupled to an opposite parallel beam of the parallel beams 102 from the parallel beam coupled to the outer tube, adjacent the first end portion 104. In embodiments, the second end portion 124 of the inner tube 120 may include a radial flange 124a (FIG. 4) extending outwardly therefrom (e.g., away from an inner portion of the inner tube 120) that is configured to abut or otherwise contact a portion of the insert 126 or the outer tube 112 to limit extension of the inner tube 120 relative to the outer tube 112 or inhibit the inner tube 120 from being fully removed from the interior channel 118 of the outer tube 112. As can be appreciated, the radial flange 124a may be formed by swaging the second end portion 124 of the inner tube, deforming the inner tube 120 to form a flange (e.g., upsetting or heading, etc.), machining, press or friction fitting a separate component, welding a separate component, amongst others. The first end portion 122 of the inner tube 120 is coupled to a second, opposite parallel beam of the pair of parallel beams 102 adjacent the first end portion 104 of the second parallel beam 102. It is envisioned that the outer tube 112 may be coupled to the parallel beam 102 using any suitable means, such as fasteners, welding, adhesives, amongst others.

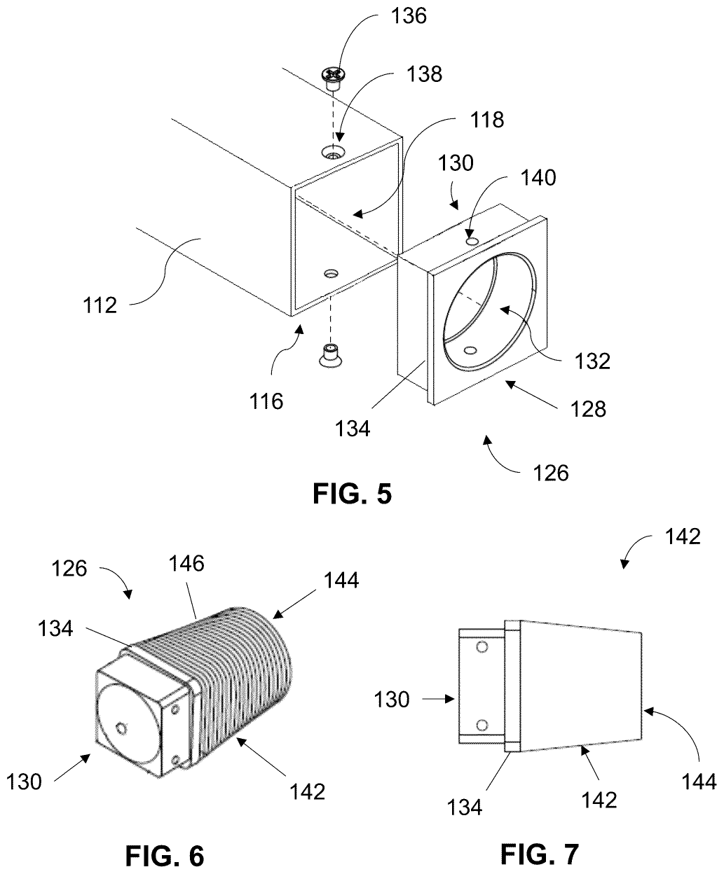

With reference to FIG. 5, the insert 126 defines a generally rectangular profile extending between a first end portion 128 and a second, opposite end portion 130, although it is envisioned that the insert 126 may include any suitable profile, such as circular, square, oval, hexagonal, amongst others without departing from the scope of the present disclosure. A throughbore 132 is defined within the insert 126 extending longitudinally through the first and second end portions 128, 130 to slidably receive a portion of the inner tube 120 therein. The throughbore 132 includes a profile that is generally complementary to that of the inner tube and includes an inner dimension that is sized to slidably support the inner tube 120 therein. In this manner, the insert 126 acts as a bushing or bearing that enables translation of the inner tube 120 within the outer tube 126. In embodiments, the insert 126 may include a flange 134 disposed thereon end extending outwardly therefrom (e.g., away from a center portion of the insert 126. It is envisioned that the flange 134 may include any suitable profile, may extend along the entire perimeter of the insert 126, may be intermittently disposed about the permitted of the insert 126 (e.g., form a plurality of tabs or flanges separated by a gap), may be a single feature (e.g., one flange covering a portion of the perimeter of the insert 126), amongst others. The flange 134 is configured to abut or otherwise contact the second end portion 116 of the outer tube 112 to inhibit further insertion or translation of the insert 126 within the interior channel 118 of the outer tube 112. It is contemplated that the insert 126 may be formed from any suitable material, such as a metal, a polymer, a composite, a ceramic, a self-lubricating material, amongst others. In one non-limiting embodiment, the insert 126 is formed from a polymer to reduce friction and wear between the inner tube 120 and the outer tube 112. It is envisioned that the insert 126 may be coupled to the outer tube 112 using any suitable means, such as friction fit, press-fit, snap fit, fasteners, adhesives, etc. In one non-limiting embodiment, the insert 126 is coupled to the outer tube 112 using one or more fasteners 136 received through a corresponding bore 138 defined through the outer tube 112 and a corresponding threaded aperture 140 defined within a portion of the insert 126.

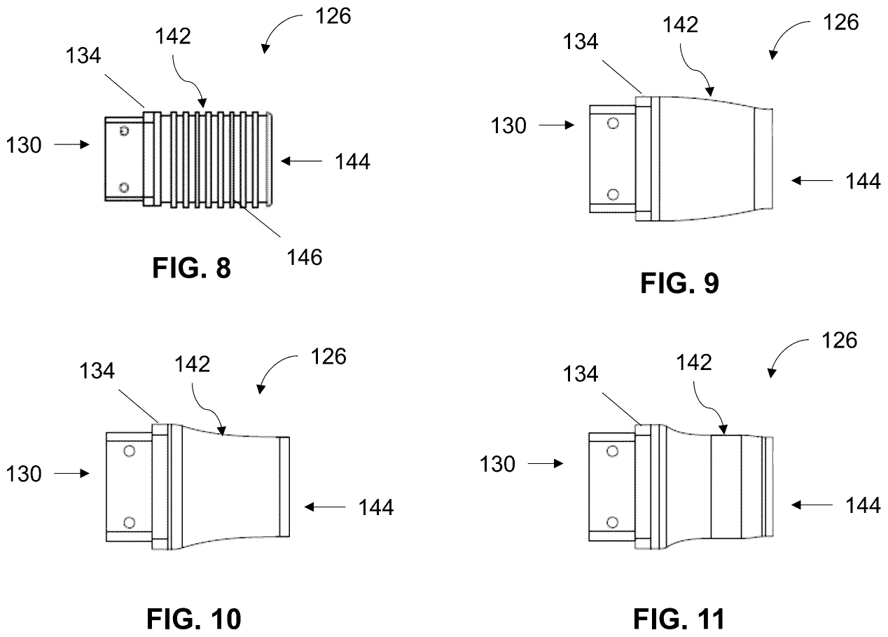

It is envisioned that the insert 126 may define any suitable configuration, and in embodiments, may define the configurations illustrated in FIGS. 6-11. In one embodiment, the insert 126 may include an elongated body 142 extending longitudinally from the flange 134 and terminating at an end portion 144. It is envisioned that the profile of the elongated body may transition from a generally square profile adjacent the flange 134 to a generally circular profile adjacent the end portion 144. In embodiments, an outer surface of the elongated body 142 may include one or more ridges, fins, or crenellations 146 disposed thereon. It is envisioned that the profile of the elongated body 142 between the flange 134 and the end portion 144 may be a conical frustum (FIGS. 6 and 7), may be linear (e.g., horizontal) (FIG. 8), may define a convex profile (FIG. 9), may define a concave profile (FIG. 10), may define a curvilinear profile (FIG. 11), combinations thereof, amongst others.

It is contemplated other than relying on gravity, one or both of the transverse beam assemblies 110 may include a biasing element (not shown) operably coupled to at least one of outer tube 112, the inner tube 120, the insert 126, the pair of parallel beams 102, etc. It is envisioned that any suitable biasing element may be utilized, such as a mechanical spring, an air spring, a gas strut, amongst others. As can be appreciated, the biasing element biases the pair of parallel beams 102 away from one another such that the autonomous cleaning system bridge 100 is biases towards the first, expanded configuration. In another embodiment, the inner tube 120 may be frictionally received within the throughbore 132 of the insert 126 to provide pre-load or an initial resistance against movement of the inner tube 120 within the insert 126.

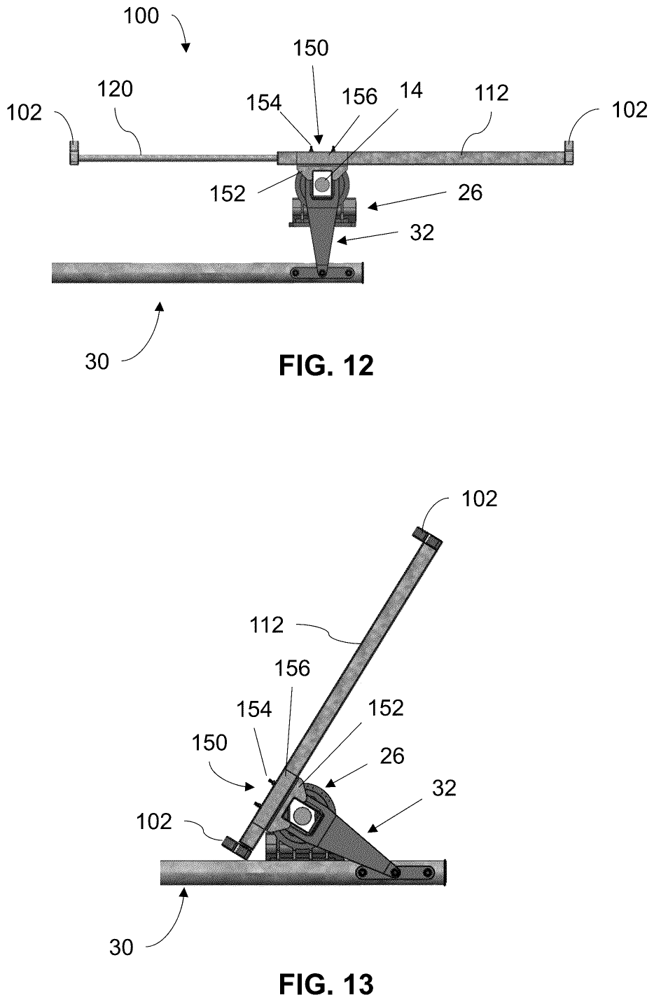

With reference to FIGS. 12 and 13, in operation, the torque tube 14 is disposed in a stow position (e.g., the rows of solar modules 12a, 12b are oriented substantially parallel perpendicular to a longitudinal axis of the pier 16). In the stow position, the autonomous cleaning system bridge 100 is in the first, expanded configuration where the pair of transverse beam assemblies 110 is oriented generally parallel with the mechanical link 30 interconnecting torque tubes 14 of adjacent rows of solar modules 12a, 12b (FIG. 12). As the torque tube 14 is rotated, effectuating a corresponding rotation of the autonomous cleaning system bridge 100 towards the mechanical link 30, a parallel beam of the pair of parallel beams 102 abuts or otherwise contacts a portion of the mechanical link 30. With the mechanical link 30 abutting the parallel beam 102, continued rotation of the torque tube 14 causes the inner tubes 120 of the pair of transverse beam assemblies 110 to translate within the inserts 126 and the outer tubes 112 to accommodate the reduced space between the torque tube 14 and the mechanical link 30 (e.g., as the torque tube 14 rotates, the mechanical link 30 is pulled towards or otherwise caused to become closer to the torque tube 14). In this manner, a distance between each parallel beam of the pair of parallel beams 102 is reduced. Further rotation of the torque tube 14 effectuates further translation of the inner tubes 120 within the inserts 126 and the outer tubes 112, ultimately placing the autonomous cleaning system bridge 100 into the second, collapsed position (FIG. 13). As can be appreciated, the autonomous cleaning system bridge 100 may be placed in any position between the first, expanded position and the second, collapsed position, depending upon the position of the mechanical link 30 relative to the autonomous cleaning system bridge 100 and the rotational position of the torque tube 14. In embodiments, the autonomous cleaning system bridge 100 accommodates ±60 degrees of rotation of the torque tube 14 relative to the stow position.

Continuing with FIGS. 12 and 13, and with additional reference to FIGS. 2 and 3, each of the pair of torque tube clamps 150 is substantially similar and therefore, only one torque tube clamp 150 will be described in detail herein in the interest of brevity. The torque tube clamp 150 includes a base 152 and a fastener 154 operably coupled to the base 152. The base 152 defines a generally inverted U-shaped or saddle profile for receipt of a portion of the torque tube 14. The base 152 is coupled to a mount 156 using any suitable means, such as fasteners, welding, adhesives, amongst others. The mount 156 is coupled to the outer tube 112 of the transverse beam assembly 110 using any suitable means, such as fasteners, welding, adhesives, amongst others. Although generally described as being coupled to the mount 156, it is envisioned that the base 152 may be coupled to the outer tube 112 of the transverse beam assembly. The fastener 154 defines a generally U-shaped configuration that is configured to receive a portion of the torque tube 14 therein. In this manner, the torque tube is received within the base 152 and the fastener 154. As the fastener is tightened or otherwise drawn towards the base 152, the torque tube 14 is squeezed or otherwise secured to the torque tube clamp 150. Although generally described as a U-bolt, it is contemplated that the fastener 154 may be any suitable fastener or plurality of fasteners capable of securing the torque tube 14 to the base 152.

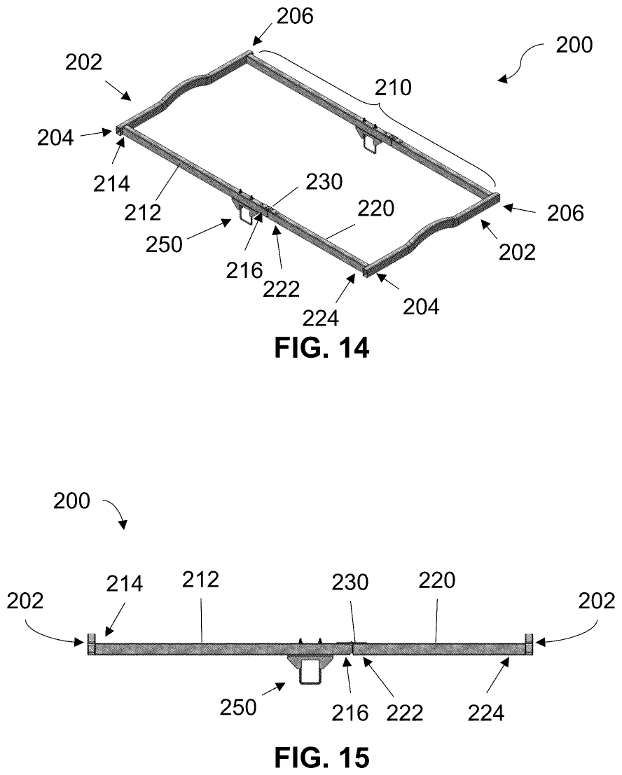

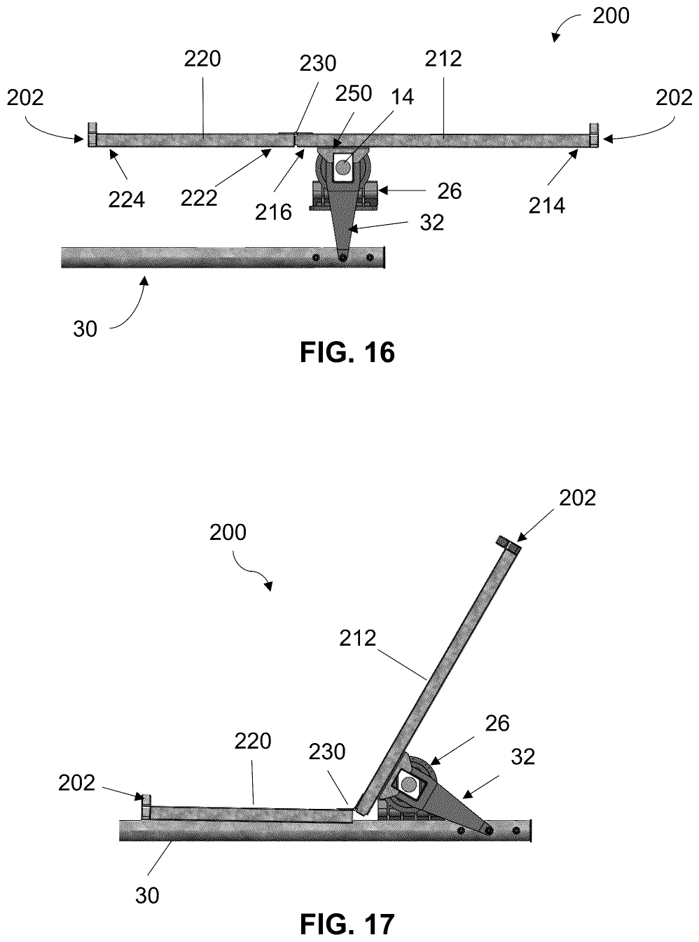

Turning to FIGS. 14-17, another embodiment of an autonomous cleaning system bridge is illustrated and generally identified by reference numeral 200. The autonomous cleaning system bridge 200 includes a pair of parallel beams 202, a pair of transverse beam assemblies 210, and a pair of torque tube clamps 250. The pair of parallel beams 202 and the pair of torque tube clamps 250 are substantially similar to the pair of parallel beams 102 and the pair of torque tube clamps 150 of the autonomous cleaning system bridge 100, and therefore, will not be described in detail herein in the interest of brevity.

Each transverse beam assembly of the pair of transverse beam assemblies 210 is substantially similar and therefore, only one transverse beam assembly 210 will be described in detail herein in the interest of brevity. The transverse beam assembly 210 includes a first tube 212, a second tube 220, and a hinge 226. The first tube 212 defines a generally rectangular profile extending between a first end portion 214 and a second, opposite end portion 216. Although generally described as defining a rectangular profile, it is envisioned that the first tube 212 may define any suitable profile, such as square, circular, oval, hexagonal, amongst others and may define one or more profile along its length without departing from the scope of the present disclosure. The first end portion 214 of the first tube 212 is coupled to a first parallel beam of the pair of parallel beams 202 adjacent the first end portion 204 of the first parallel beam 202. It is envisioned that the first tube 212 may be coupled to the first parallel beam 202 using any suitable means, such as fasteners, welding, adhesives, amongst others. It is contemplated that the first tube 212 may be formed from any suitable material, such as a metal, a polymer, a composite, amongst others and may be solid or hollow along a portion or the entirety of its length. In one non-limiting embodiment, the first tube 212 is formed from a rectangular tube (e.g., box tubing, etc.) having a hollow interior portion.

The second tube 220 defines a profile generally complimentary to the profile of the first tube 212 and extends between a first end portion 222 and a second, opposite end portion 224. Although generally described as defining a profile that is complementary to the profile of the first tube 212, it is envisioned that the second tube 220 may define any suitable profile and may define the same or different profile than the profile of the first tube 212. The second end portion 224 of the second tube 220 is coupled to a second, opposite parallel beam of the pair of parallel beams 202 adjacent the first end portion 204 of the second parallel beam 202. It is envisioned that the second tube 220 may be coupled to the second parallel beam 202 using any suitable means, such as fasteners, welding, adhesives, amongst others. It is contemplated that the second tube 220 may be formed from any suitable material, such as a metal, a polymer, a composite, amongst others and may be solid or hollow along a portion or the entirety of its length. In one non-limiting embodiment, the second tube 220 is formed from a rectangular tube (e.g., box tubing, etc.) having a hollow interior portion.

The second end portion 216 of the first tube 212 is hingedly coupled to the first end portion 222 of the second tube 220 using a hinge 230. In this manner, a first portion of the hinge 230 is coupled to the second end portion 216 of the first tube 212 and a second portion of the hinge 230 is coupled to the first end portion 222 of the second tube 220 to enable the first and second tubes 212, 220 to rotate relative to one another about an axis that is transverse to a longitudinal axis of the first and second tubes 212, 220 (e.g., fold in a clamshell or book like manner). It is envisioned that the hinge 230 may be any suitable flexible joining device, such as a pinned type hinge, a living hinge or flexure, amongst others. In one non-limiting embodiment, the first and second tubes 212, 220 may be formed as a single component defining a reduced thickness portion acting as a living hinge. It is contemplated that the hinge 230 may be coupled to each of the first and second tubes 212, 220 using any suitable means, such as fasteners, welding, adhesives, amongst others. As can be appreciated, the hinge 230 enables the autonomous cleaning system bridge 200 to transition from a first, linear position (FIG. 14) to a second, folded position (FIG. 15) to accommodate reduced space between the torque tube 14 and the mechanical link 30 as the torque tube 14 is rotated.

The torque tube clamp 250 is coupled to the first tube 212 adjacent the second end portion 216 such that the first tube 212 rotates in unison with the torque tube 14. Although generally illustrated as having a length that is longer than the second tube 220, it is envisioned that the first tube 212 may include any suitable length depending upon the design needs of the autonomous cleaning system bridge 200. In this manner, in operation, as the torque tube 14 rotates, effectuating a corresponding rotation of the autonomous cleaning system bridge 200, the second parallel beam of the pair of parallel beams 202 abuts a portion of the mechanical link 30. Continued rotation of the torque tube effectuates continued rotation of the autonomous cleaning system bridge 200 causing the mechanical link 30 to urge the second parallel beam of the pair of parallel beams 202, along with the second tubes 220, to rotate about the hinge 230 to permit further rotation of the torque tube and inhibit damage to the autonomous cleaning system bridge 200, the mechanical link 30, the solar modules 12, etc. As can be appreciated, the autonomous cleaning system bridge 200 may be placed in any position between the first, linear position and the second, folded position, depending upon the position of the mechanical link 30 relative to the autonomous cleaning system bridge 200 and the rotational position of the torque tube 14. In embodiments, the autonomous cleaning system bridge 200 accommodates ±60 degrees of rotation of the torque tube 14 relative to the stow position.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

1. An autonomous cleaning system bridge, comprising:
a pair of parallel beams; and
a pair of transverse beam assemblies interposed between the pair of parallel beams and disposed in spaced relation to one another, each transverse beam assembly of the pair of transverse beam assemblies including:
an outer tube extending between a first end portion and an opposite, second end portion, the first end portion of the outer tube coupled to a first parallel beam of the pair of parallel beams;
an insert coupled to the second end portion of the outer tube, the insert defining a through-bore; and
an inner tube extending between a first end portion and an opposite, second end portion, the second end portion of the inner tube coupled to a second parallel beam of the pair of parallel beams, wherein the inner tube is slidably supported within the through-bore of the insert to enable the autonomous cleaning system bridge to transition from a first, expanded configuration to a second, collapsed configuration due to contact between the second parallel beam of the pair of parallel beams and a portion of a solar tracker system.

2. The autonomous cleaning system bridge according to claim 1, wherein the portion of the solar tracker system is a mechanical linkage coupling a first row of solar modules to a second row of solar modules.

3. The autonomous cleaning system bridge according to claim 1, wherein the insert is formed from a polymer.

4. The autonomous cleaning system bridge according to claim 1, wherein a flange is defined on the first end portion of the inner tube to limit translation of the inner tube relative to the outer tube.

5. The autonomous cleaning system bridge according to claim 1, wherein the insert is coupled to the outer tube by a snap fit.

6. The autonomous cleaning system bridge according to claim 1, wherein the insert is coupled to the outer tube by a friction fit.

7. The autonomous cleaning system bridge according to claim 1, wherein the insert is coupled to the outer tube using fasteners.

8. The autonomous cleaning system bridge according to claim 1, wherein the pair of parallel beams define an arcuate center portion to provide clearance between the pair of parallel beams and a component of a solar tracking system.

9. An autonomous cleaning system bridge, comprising:
a pair of parallel beams; and
a pair of transverse beam assemblies interposed between the pair of parallel beams and disposed in spaced relation to one another, wherein each transverse beam assembly of the pair of transverse beam assemblies is transitionable from a first position, permitting an autonomous cleaning system to traverse the autonomous cleaning system bridge, to a second position in response to contact between a parallel beam of the pair of parallel beams with a portion of a solar tracking system.

10. The autonomous cleaning system bridge according to claim 9, wherein the portion of the solar tracking system is a mechanical linkage coupling a first row of solar modules to a second row of solar modules.

11. The autonomous cleaning system bridge according to claim 9, wherein the first position of the pair of transverse beam assemblies defines a linear configuration.

12. The autonomous cleaning system bridge according to claim 9, wherein the second position of the pair of transverse beam assemblies defines a folded configuration.

13. The autonomous cleaning system bridge according to claim 9, wherein each transverse beam assembly of the pair of transverse beam assemblies includes a first tube and a second tube hingedly coupled to the first tube.

14. The autonomous cleaning system bridge according to claim 9, wherein the first position of the transverse beam assemblies defines an expanded configuration and the second position defines a collapsed configuration.

15. The autonomous cleaning system bridge according to claim 14, wherein each transverse beam assembly of the pair of transverse beam assemblies includes a first tube and a second tube slidably supported within the first tube.

16. An autonomous cleaning system bridge, comprising:
a pair of parallel beams; and
a pair of transverse beam assemblies interposed between the pair of parallel beams and disposed in spaced relation to one another, each transverse beam assembly of the pair of transverse beam assemblies including:
a first tube extending between a first end portion and an opposite, second end portion, the first end portion of the first tube coupled to a first parallel beam of the pair of parallel beams;
a second tube extending between a first end portion and an opposite, second end portion, the second end portion of the second tube coupled to a second parallel beam of the pair of parallel beams; and
a hinge coupled to the second end portion of the first tube and the first end portion of the second tube, the hinge permitting rotation of the first tube and the second tube relative to one another from a first position to a second position due to contact between the second parallel beam of the pair of parallel beams and a portion of a solar tracker system.

17. The autonomous cleaning system bridge according to claim 16, wherein the portion of the solar tracking system is a mechanical linkage coupling a first row of solar modules to a second row of solar modules.

18. The autonomous cleaning system bridge according to claim 16, wherein the first position of the pair of transverse beam assemblies defines a linear configuration.

19. The autonomous cleaning system bridge according to claim 16, wherein the second position of the pair of transverse beam assemblies defines a folded configuration.

20. The autonomous cleaning system bridge according to claim 16, wherein the hinge is coupled to an outer surface of the first tube and an outer surface of the second tube.
